(19) United States
(12) Patent Application Publication
(10) Pub. No.: US 2011/0220851 A1
(43) Pub. Date: Sep. 15, 2011

(54) DISPERSION OF CARBON NANOTUBES AND NANOPLATELETS IN POLYOLEFINS

(75) Inventors: Hung-Jue SUE, College Station, TX (US); Minhao WONG, College Station, TX (US); Chien-Chia CHU, College Station, TX (US); Yukihito ZANKA, Jeffersonville, IN (US); Yuuji RYOUSHO, Yokkaichi-shi (JP)

(73) Assignees: JAPAN POLYPROPYLENE CORPORATION, Tokyo (JP); TEXAS ENGINEERING EXPERIMENTAL STATION, College Station, TX (US)

(21) Appl. No.: 12/979,744

(22) Filed: Dec. 28, 2010

Related U.S. Application Data
(60) Provisional application No. 61/290,465, filed on Dec. 28, 2009.

(51) Int. Cl. H01B 1/24; C08K 3/32; C08K 5/17; C08J 3/22; H01B 1/12; C08L 23/12; B29C 49/00; B82Y 99/00; B82Y 30/00

(52) U.S. Cl. 252/507; 524/413; 524/251; 523/351; 252/511; 252/500; 264/523; 977/752; 977/748; 977/783; 977/750; 977/734

(57) ABSTRACT

A method of dispersing nanotubes and/or nanoplatelets in a polyolefin is provided, involving A) preparing a solution comprising nanotubes or nanoplatelets or both; B) stirring the resulting solution from step (A); C) dissolving at least one polymeric material in the stirred solution from step (B) and isolating precipitates from the solution; and D) melt-blending the precipitates with at least one polyolefin, along with the nanocomposites prepared thereby, and articles formed from the nanocomposites.

### REFERENCE TO RELATED APPLICATIONS

The present application claims priority to U.S. Provisional Application 61/290,465, filed Dec. 28, 2009, the entire contents of which are hereby incorporated by reference.

### BACKGROUND OF THE INVENTION

1. Field of Invention

This invention relates to polymer nanocomposites. More particularly, the invention concerns polymeric nanocomposites containing finely dispersed nanosized particles such as nanotubes and/or nanoplatelets in polyolefins.

2. Discussion of the Background

Polyolefin is one of the most widely used, commercially produced polymers. For engineering applications, polypropylene (PP) is considered attractive for its high melting temperature, relatively high modulus, low cost, and recyclability. There are many attempts to improve its properties to further expand its range of applications. One such strategy to effect improvement is by including nanosized fillers into PP. The material property that can be improved is dependent on the type of nano-filler utilized. Some commonly used fillers are silicate-based nano-clays such as montmorillonite. Silicate-based nano-clays are used to improve rigidity, strength, gas barrier property, heat distortion temperature and flame retardancy of polymers. It has been found to be particularly useful in improving polyamides, most notably nylon 6 [Refs. 27 and 28], polyimides or polymers containing amide or imide groups Impressive improvement is seen when nano-clays are well exfoliated in the polymer matrix. However, there has been less success in exfoliating silicate-based nano-clays in PP. A notable example is the use of a polyolefin oligomer with telechelic hydroxyl group to intercalate into the gallery of montmorillonite clay ion-exchanged with dioctadecyl dimethyl ammonium ions [Ref. 29]. It was found that increasing the amount of oligomer resulted in better exfoliation of nano-clay. A further improvement of this method is the use of a stearylammonium-exchange montmorillonite and maleic anhydride modified PP (PP-MA). PP-MA acts as a compatibilizer with neat PP [Refs. 30-32]. Nanoclay can be largely exfoliated into PP by employing this method. The ratio of PP-MA to nano-clay is crucial and it was found that the ratio 3:1 yielded the highest degree of exfoliation. Even though exfoliation was achieved in PP, the improvement in physical properties over neat PP was not comparable to those seen in the nylon-clay hybrids, a fact most likely due to the incomplete exfoliation of clay and the presence of PP-MA. As PP is highly hydrophobic and clay is highly hydrophilic, it is recognized that an intermediary is necessary to mediate the interaction between such highly incompatible materials. Any method that would eliminate or significantly reduce the use of a compatibilizer is highly desirable.

A different class of nanofillers, such as carbon nanotubes (CNTs), can also be used in PP. Carbon nanotubes (CNTs) possess remarkable mechanical, electrical, and thermal properties [Refs. 1 and 2], but experimental results attempting to transfer these properties to polymer matrices have shown only limited success because of poor dispersion and inadequate interfacial adhesion between the CNTs and the polymer matrix [Ref. 3]. CNTs were also found to improve flame retardancy of PP as well as nano-clay [Ref 33]. The most common approaches to achieve good dispersion include surfactant wrapping [Refs. 4 and 5], covalent functionalization [Refs. 6-9], and non-covalent functionalization [Refs. 10-16]. Among them, non-covalent bonding based on acid-base functionalization with long alkyl chains attached to the CNT surfaces has been shown to be highly effective with higher yield than other methods, and are applicable to several different classes of polymers. The attachment of alkyl chains to CNTs is generally accomplished by ionic bonding between oxidized CNT surfaces and aliphatic amine functionality [Refs. 12 and 13]. It has been well established that amine functionality possesses strong affinity to interact with carboxylic acid functionality on the CNT surface via ionic bonding. The noncovalent bonding between acid-treated CNTs and octadecylamine has been demonstrated to yield stable dispersion of CNTs in organic solvent via the formation of zwitterions [Refs. 12-16].

Several methods have also been attempted to disentangle multi-walled carbon nanotubes (MWCNTs), but have not been able to show good dispersion at the individual level. Koval'chuk et al [Refs. 17 and 18] achieved good dispersion of MWCNTs in PP using aliphatic amine to achieve alkylation on CNT surface. This approach is simple, insensitive to air, and can result in a high degree of functionalization, but still contained entangled structures of MWCNT in the composite. Jung et al [Ref 19] used octadecylamine for functionalization and demonstrated that longer alkyl chains are more beneficial for dispersion, but were not able to achieve individual dispersion after mixing with PP. The above mentioned approaches are able to improve CNT compatibility with the PP matrix, but have not adequately demonstrated disentangled dispersion of CNTs in the nanocomposite material.

Bao and Tjong [Ref. 34] studied the effect of melt blending of MWCNT in a twin screw extruder with PP and found significant improvement in tensile modulus (33% increase) and tensile strength (16% increase) at 0.3% wt of MWCNT. However, further increase of MWCNT loading did not produce significant improvement. Fereidoon et al studied the melt-blending of single-walled CNT (SWCNT) with PP and was able to achieve 82% increase of tensile modulus and 22% increase of tensile strength at 1% wt SWCNT. A more sophisticated approach used by Blake et al is to prepare n-butyllithium-functionalized MWCNT followed by a coupling reaction with chlorinated PP (CL-PP) [Ref. 35]. This method yielded MWCNT that was coated by a layer of CL-PP, thereby enhancing its miscibility in CL-PP. An impressive 209% and 277% improvement in tensile modulus and strength, respectively, was reported. This study suggests that the reinforcement effect achievable is strongly dependent on the state of dispersion of the CNTs. However, the use of CL-PP as the host polymer indicates that it is necessary to modify the host polymer to achieve such impressive results. Others have found that MWCNT functionalized by heating in air exhibited good compatibility with PP provided that a compatibilizer such as PP-MA is used [Ref. 36]. In this case, micron sized aggregates of MWCNT were formed. Studies have shown that CNTs can be used to improve conductivity in polyolefins [Refs. 36 and 37]. The inclusion of about 1 vol % of MWCNTs in PP can induce a seven order increase in volume conductivity [Ref. 38]. It was also shown that at 10 wt % of MWCNT, the volume resistivity decreases by 16 orders of magnitude [Ref. 39]. Thus, CNTs is an excellent material to improve the electrical properties of polyolefins.

From the above background, one can thus concludes that a practical method to enhance the dispersion of nanoparticles or nanotubes, such as CNT, in unmodified polyolefins, such as PP, is still lacking and there is a need to develop a technique that can achieve nano-dispersion of such nanoparticles without the use of significant chemical modification or large amounts of compatibilizer.

### SUMMARY OF THE INVENTION

Accordingly one object of the present invention is to provide a method for highly efficient dispersion of nanoplatelets, nanotubes or both in a polyolefin.

A further object of the present invention is to provide a method for dispersion of nanoplatelets, nanotubes or both in a polyolefin by surface modification of the nanoplatelets, nanotubes, or polyolefin.

A further object of the present invention is to provide nanocomposites prepared according to the method of the present invention.

A further object of the present invention is to provide articles prepared from the nanocomposites.

These and other objects of the present invention, either individually or in combinations thereof, have been satisfied by the discovery of a method of dispersing nanotubes and/or nanoplatelets in a polyolefin, comprising:

A) preparing a solution comprising nanotubes or nanoplatelets or both;

B) stirring the resulting solution from step (A);

C) dissolving at least one polymeric material in the stirred solution from step (B) and isolating precipitates from the solution; and

D) melt-blending the precipitates with at least one polyolefin,

and nanocomposites formed therefrom.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a transmission electron micrograph of the masterbatch of CNT/ZrP/PP obtained by precipitation of the CNT/ZrP and PP from solution. Both the CNT and ZrP nanoplatelets are well-dispersed in the PP host. The composition of the precipitates is CNT/tetra(n-butylammonium)hydroxide (TBA)/ZrP/PP=1/2/3/4 in weight ratio.

FIG. 2 is an X-ray diffraction spectrogram of neat PP pellets and nanocomposite sample JPP-D. The charts indicate presence of α-phase crystals of PP. The absence of diffraction peaks from stacked ZrP nanoplatelets indicate that the nanoplatelets are likely exfoliated.

FIG. 3 is a transmission electron micrograph of 0.05 wt % MWCNT dispersed in PP. The MWCNTs are significantly individually dispersed without aggregation.

FIG. 4 is a field emission scanning electron micrograph of plasma-treated PP particles. Particle size is about 100 microns.

FIG. 5 is a transmission electron micrograph of plasma-treated PP particles (P-PP-1) with ZrP nanoplatelets attached to the particle surface.

FIG. 6 is a transmission electron micrograph of ZrP nanocomposite sample P-PP-1 which was hot pressed into a thin sheet. Individually dispersed nanoplatelets were observed.

FIG. 7 is a transmission electron micrograph of 0.015 wt % ZrP nanocomposite sample P-PP-8 showing the homogeneous dispersion of nanoplatelets of about 100 nm in size.

FIG. 8 is a transmission electron micrograph of 0.015 wt % ZrP nanocomposite sample P-PP-8 showing the homogeneous dispersion of nanoplatelets of 100 nm in size.

FIGS. 9a-9d are TEM micrographs of (a, b) of MWCNT after a slight oxidation showing significant entanglement and (c, d) well-dispersed MWCNT after the nanoplatelets-assisted dispersion process.

FIGS. 10a-10d is a conceptual representation of the method of the present invention for (a-b) preparation of individual MWCNTs surface modified by octadecylamine and (c-d) preparation of well-dispersed MWCNTs in PP.

FIG. 11 shows FTIR spectra of (top) slightly oxidized MWCTN and (bottom) F-MWCNT.

FIGS. 12a and 12b are TEM micrographs of well-dispersed FD-MWCNTs after removal from xylene solution.

FIGS. 13a and 13b are TEM micrographs of PP/FD-MWCNT nanocomposite prepared from xylene solution.

FIGS. 14a-14h are TEM images of PP nanocomposites containing a, b) 0.1 wt. %; c, d) 0.6 wt. %; e, 1 wt. % and g, h) 2 wt. % of MWCNTs.

FIG. 15 represents engineering stress—true strain curves of the neat PP and PP nanocomposites containing well-dispersed MWCNTs.

FIGS. 16a-16d are fracture surfaces of SEM of a, b) neat PP and c, d) 0.1 wt. % F-MWNT nanocomposite.

FIG. 17 shows surface electrical conductivities of PP nanocomposites containing various concentrations of F-MWCNT.

FIGS. 18a-18c show measurements of dimensional stability (i.e. shrinkage in the thickness direction) of (a) neat PP, (b) 0.1 wt % MWCNTs in PP, and (c) 0.4 wt % MWCNTs in PP.

### DETAILED DESCRIPTION OF THE INVENTION

The present invention relates to a simple process to achieve greatly improved dispersion of nanoparticles or nanotubes, particularly MWCNTs, in polyolefins, particularly in PP. The present invention more particularly relates to achieving greatly improved dispersion of (i) nanotubes, such as MWCNTs, in polyolefins such as PP, (ii) clays or nanoplatelets, such as ZrP, in polyolefins such as PP, or (iii) a combination of nanotubes and clay or nanoplatelets in polyolefins such as PP.

In the present inventors previous work, nanoplatelets were electrostatically tethered to slightly oxidized CNT surfaces to achieve disentanglement and debundling of both MWCNTs and SWCNTs with minimal damage to the electronic state of the CNTs [Ref. 20]. To maintain dispersion and disentanglement of the exfoliated CNTs in organic solvents and polymer matrices, organophilic modification of the CNT surface is particularly needed.

The polyolefins of the present invention compositions are preferably polyethylene (PE), polypropylene (PP), polybutylene (PB) or blends or copolymers thereof. More preferably, the polyolefin is PP. Throughout the discussion below, the present invention will be described with respect to the polyolefin being polypropylene (PP). However, this is not intended to be limiting to the present invention, and other polyolefins may be used instead of PP, such as polyethylene, polybutylene, etc.

In the present invention, the organophilic modification can be provided by at least one member selected from the group consisting of long chain aliphatic amines and maleic anhydride modified polypropylene (PP-MA; see Refs. 30-32). Preferably, the organophilic modification is provided by the use of a medium to long chain aliphatic amine (for simplicity hereafter called “long chain aliphatic amine”), wherein the amine is more preferably a primary amine. The medium to long chain aliphatic amine can have any desired number of carbon atoms in each aliphatic chain, so long as the number of carbons is sufficient to provide the desired organophilic properties to the nanotube or nanoplatelet being modified. Preferably, the long chain aliphatic amine has a C4-C30 aliphatic group, more preferably a C6-C30 group, still more preferably a C10-C30 group, more preferably a C14-C24 group, even more preferably a C16-C20 group, and most preferably a C18 group. The organophilic modification can be made to the surface of the nanotubes, to the surface of the clay or nanoplatelets, or to the polyolefin surface. In a most preferred embodiment, octadecylamine is chosen to produce functionalized multi-walled carbon nanotubes (F-MWCNT), which can be easily dispersed in organic solvents, such as xylene, decalin, butanol, di-chlorobenzene, tri-chlorobenzene, N,N-dimethylformamide and isopropanol, with mild sonication. The solution can then be directly mixed with a polyolefin, such as PP pellets, and dried to yield polyolefin/F-MWCNT nanocomposites with significantly improved electrical conductivity and tensile modulus at low loadings. The same solvents noted above can also be used in the dispersion of functionalized nanoplatelets or clays.

Nanotubes useful in the present invention can be any desired nanotubes. Preferably, the nanotubes are at least one member selected from the group consisting of carbon nanotubes, tungsten dioxide nanotubes, silicon nanotubes, inorganic nanotubes, and combinations thereof. More preferably the nanotubes are carbon nanotubes, and most preferably are SWCNTs or MWCNTs. The nanotubes can be surface oxidized if desired, using any known oxidation method, including but not limited to, dry oxidation, radiation oxidation, plasma oxidation, thermal oxidation, diffusion oxidation or combinations thereof.

The nanoplatelets used in the present invention can be a clay or other form of nanoplatelet, including, but not limited to, clay (such as montmorillonite), nanoclay, graphene, inorganic crystals, organic crystals, and combinations thereof. In particular, the nanoplatelets are preferably α-zirconium phosphate (ZrP). ZrP can be regarded as synthetic clay as it has a similar layered structure to the more well-known natural clays like montmorillonite. ZrP has a well defined chemical structure Zr(HPO₄)₂.H₂O, unlike natural clay where the cationic constituents can vary depending on the source of the clay. The size and aspect ratio of ZrP can also be controlled easily by varying synthesis conditions, giving a more uniform size distribution than natural clays [Ref 40]. ZrP can be intercalated by onium ions in a similar way to montmorillonite and exfoliation in aqueous solution is easily achieved by the introduction of TBA⁺OH⁻ to form tetra(n-butylammonium)ion (TBA⁺), which intercalates and subsequently exfoliates ZrP [Ref 41]. The present invention uses ZrP as a substitute for natural clay but the methods developed here are also applicable to natural clays, due to similar chemistry and physical properties.

The present invention provides a simple, yet effective method to fabricate polyolefin nanocomposites containing well-dispersed nanotubes or nanoplatelets. In particular, the present invention preferably provides a simple, effective method to fabricate polyolefin nanocomposites containing well-dispersed MWCNTs. Slightly oxidized MWCNTs can be disentangled using nanoplatelets and show high stability even after the nanoplatelets are removed. The well-dispersed MWCNTs are preferably functionalized with octadecylamine and demonstrate increased stability in organic solvents even at the individual dispersed state, as evidenced by TEM and SEM observation. Well-dispersed polyolefin/MWCNT nanocomposites can be prepared by direct mixing of the polyolefin pellets with an organic solvent, such as a xylene solution, containing a high concentration of MWCNT. Upon drying, the powders were used as a masterbatch to be diluted in neat PP to form nanocomposites with the desired MWCNT concentration. The nanocomposites show excellent dispersion and exhibit significant increases in modulus, strength, and electrical conductivity at low tube loading. The mechanism for mechanical properties reinforcement has not been explicitly determined, but it is proposed to be partially due to the fact that MWCNTs serve as (1) a nucleation agent for crystal growth and (2) reinforcement in the inter-spherulitic region of the matrix to effectively strengthen the polyolefin matrix.

One embodiment of the present invention is a method of dispersing nanoplatelets and/or nanotubes in a polyolefin, comprising:

A) preparing a solution comprising nanotubes and nanoplatelets;
B) stirring the resulting solution from step (A);
C) dissolving at least one polymeric material in the stirred solution from step (B) and isolating precipitates from the solution;
D) melt-blending the precipitates with at least one polyolefin.

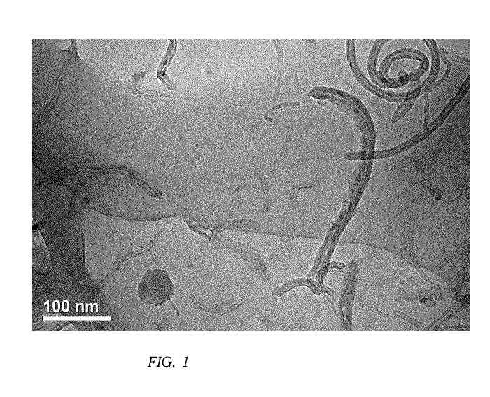

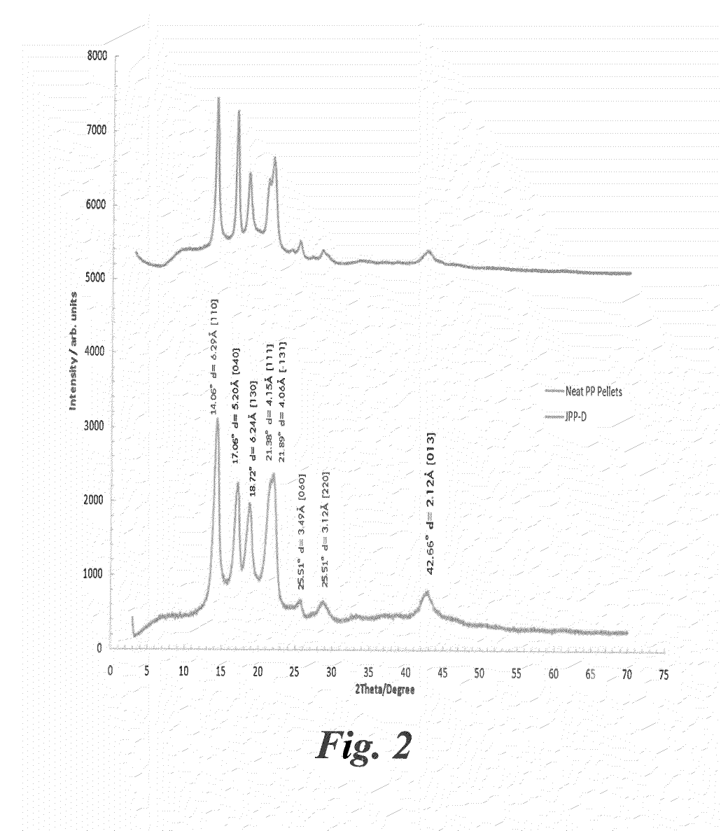

The present inventors have previously developed a novel method to co-disperse carbon nanotubes and nanoplatelets such as ZrP in aqueous solution [Ref. 20]. This solution can be used as the initial step in the above noted embodiment of the present invention method of preparing polyolefin nanocomposites. The aqueous solution is preferably heated until it becomes a viscous slurry with a gel-like consistency. This is then redispersed in a solvent such as N,N-dimethylformamide (DMF). A PP/decalin solution is prepared which is mixed with the DMF solution of CNT/ZrP and isopropanol. This solution is sonicated in a hot water bath at 80° C. followed by stirring at 90° C. for 30 minutes and finally cooled to room temperature. The black precipitates that form during cooling are collected and washed with isopropanol and dried in a vacuum oven. The black precipitate, containing 10% CNT, 20% TBA, 30% ZrP and 40% PP, is preferably used as a masterbatch for melt-blending with PP to make a polymer nanocomposite. TEM images of the masterbatch redispersed in isopropanol show that MWCNT and ZrP nanoplatelets are individually dispersed in the polymer matrix (FIG. 1). Nanocomposites with 1 wt % MWCNT/3 wt % ZrP were made into injection molded bars. A sample is analyzed by X-ray diffraction (XRD) and compared to the results from neat PP pellets. XRD spectrograms show that the distinct diffraction peaks from unexfoliated ZrP are absent and that only α-phase crystals of PP are detected (FIG. 2). Instead of the PP/decalin solution which is mixed with the solution of CNT/ZrP, any other polymeric materials can be used, including, but not limited to, polyethylene terephthalate, polybutylene terephthalate, polyestercarbonate copolymers, poly(ester-carbonate) resins, polyamides, high temperature polyamides, polyethylene, polypropylene, copolymers of olefins, functionalized polyolefin, halogenated vinyl polymers, vinylidene polymers, polyvinylidene chloride, polyvinyl fluoride, polyvinylidene fluoride, polyamide copolymers, polyacrylonitrile, polyethers, polyketones, thermoplastic polyimides, modified celluloses, and mixtures including at least one of the foregoing polymeric materials. The resulting mixture with the CNT/ZrP solution is then treated to form precipitates of CNT/ZrP/polymeric material, which can be used as a masterbatch to melt-blend with the polyolefin to obtain the final nanocomposite. Of course, the use of PP as the at least one polymeric material is preferred in order to provide a nanocomposite wherein the only polymeric material is PP.

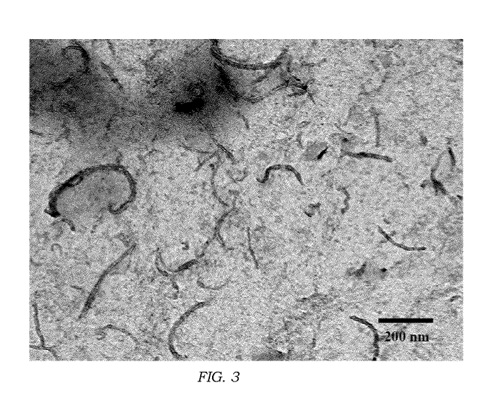

Alternatively, in a separate embodiment, the ZrP nanoplatelets can be separated from the CNT after dispersion in water using the method described by Xi et al. [43] The CNT can be redispersed in a non-polar solvent, such as decalin, after organophilic modification with a long chain aliphatic amine, such as octadecylamine. The CNT/xylene solution is added slowly to a hot, stirring solution of PP (or other polymeric material)/xylene, which ensures homogeneous mixing of the CNT with PP. Solution stirring is stopped and upon cooling, CNT co-precipitates with PP in solution. The precipitate is separated from solution and dried to form a well-dispersed PP/CNT nanocomposite (FIG. 3).

The ZrP can be dispersed in a non-polar solvent system, such as xylene or decalin, after removing the TBA and modification by a long chain aliphatic amine, such as octadecylamine. The ZrP/xylene solution is added slowly into a hot, stirring solution of PP/decalin to ensure good dispersion of ZrP in PP. Afterwards, the solution is cooled to allow for ZrP co-precipitation with PP in decalin. The precipitates are separated from solution and dried to form a well-dispersed PP/ZrP nanocomposite.

Two well-dispersed solutions of ZrP/xylene and CNT/xylene can also be mixed together to form a homogeneous suspension. The mixture can then be added slowly to a hot, stirring solution of polymeric material, preferably PP/decalin to ensure good dispersion of ZrP/CNT in the polymeric material, preferably PP. Afterwards, the solution is cooled to allow for ZrP/CNT co-precipitation with PP in decalin. The precipitates are separated from solution and dried to form a well-dispersed PP/CNT/ZrP nanocomposite.

The nanocomposites of the present invention may contain any desired loading of nanotubes and/or nanoplatelets. Preferably the amount of nanotubes or nanoplatelets is in a range from 0.1 to 20% by weight, more preferably from 0.1 to 10% by weight, most preferably from 0.3 to 5% by weight. In a more preferred embodiment, the nanocomposite of the present invention comprises 95 to 99.7% by weight of polyolefin, and 0.3 to 5% by weight of nanotubes, preferably MWCNTs. The percolation concentration can change with the aspect ratios of the CNT. In the most preferred embodiment noted above, having a concentration of 0.3 to 5% by weight of MWCNTs, the composition has a surface electrical conductivity of more than 10⁻⁶ S/m.

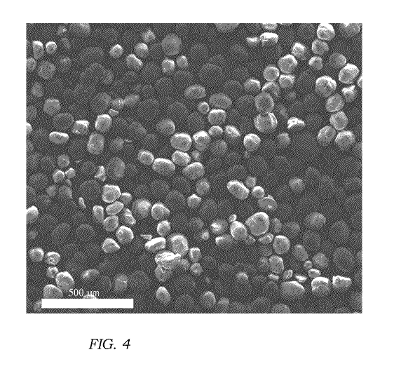

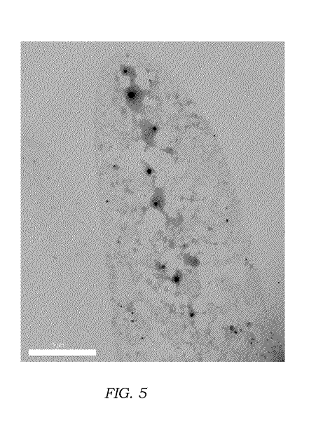

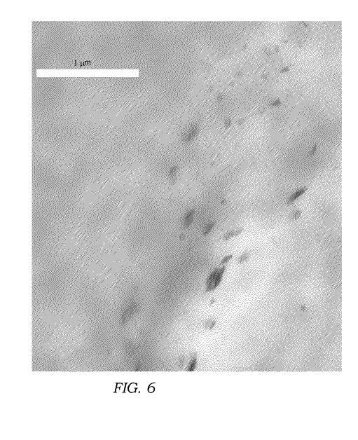

In a further embodiment of the current invention, plasma treated PP (PT-PP) particles with a size of 100 microns (FIG. 4) are mixed with ZrP in aqueous solution. The PT-PP particles have been treated with plasma in the presence of air and nitrogen, resulting in functional chemical groups such as COOH, C═O, C—O, NO₂ and NO₃ attached to the surface of the particles. These groups are generally electron rich and in particular, the carboxylic acid group deprotonates easily in water to form carboxylate ion, imparting a negative charge to the particles. ZrP nanoplatelets that have been modified by TBA possess a positive charge. Electrostatic attraction between the particle and nanoplatelets compels the formation of a layer of ZrP surrounding each particle. The PT-PP particles once treated with ZrP form a stable suspension in water. This can also be carried out with addition of TBA⁺OH⁻ into the solution to raise the pH. Raising the pH increases the concentration of deprotonated carboxylate groups on the surface of the PT-PP particles and is believed to increase the attraction of ZrP to the particles. Addition of excess acetone disrupts the stable suspension and forces the sedimentation of ZrP coated polymer particles. The particles are collected and dried in an oven at 90° C. Some of the particles are embedded in epoxy and used to prepare thin sections for TEM to observe the morphology of the ZrP coated polymer particles. The rest of the particles are hot-pressed to form thin sheets, where they are embedded in epoxy to form thin sections across the cross sections of the pressed sheets. These thin sections are also used for TEM imaging. From the analysis of TEM images, we have found evidence of ZrP nanoplatelets attaching to the surface of PT-PP particles (FIG. 5). The TEM images of the cross section of the pressed thin sheets show that individual nanoplatelets can be seen dispersed in the polymer matrix (FIG. 6).

The nanocomposites of the present invention may optionally contain one or more conventional additives in conventional amounts. The one or more additives preferably include, but are not limited to, one or more additives selected from the group consisting of fillers, reinforcing agents, plasticizers, antioxidants, heat stabilizers, ultraviolet stabilizers, tougheners, antistatic agents, flame retardant, colorants, and a combination containing at least one of the foregoing additives.

The nanocomposites of the present invention may be used to form a variety of articles, such as films, foams, fibers, and other structural forms. These articles may be formed by any conventional process, including, but not limited to, thermoforming, extrusion molding, blow molding, stretch blow molding, extrusion blow molding, etc.

Having generally described this invention, a further understanding can be obtained by reference to certain specific examples which are provided herein for purposes of illustration only and are not intended to be limiting unless otherwise specified.

### EXAMPLES

### Materials

ZrP nanoplatelets were used to disentangle and disperse the MWCNTs in aqueous solution. The synthesis, exfoliation, and use of ZrP for MWCNT disentanglement has been reported previously [20, 21]. Briefly, 15.0 g of ZrOCl₂.8H₂O (Fluka) was refluxed in 150.0 mL of 3.0 M H₃PO₄ (EM Science) under mechanical stirring at 100° C. for 24 hours. The products were subsequently washed three times through centrifugation and redispersion, dried at 85° C. in an oven for 24 hrs, and gently ground with a mortar and pestle into a fine powder. The ZrP powder was exfoliated with TBA⁺OH⁻ (Aldrich, 1 mol/L in methanol) at a molar ratio of ZrP:TBA=1:0.8 in water. Pristine MWCNT (P-MWCNTs) (purity 90%, average diameter <10 nm, length range 0.1-10 μm) were purchased from Aldrich. A commercially available octadecylamine (CH₃(CH₂)₁₇NH₂, Sigma-Aldrich Chemicals, 97%) was used as received. A commercial grade PP, designation 4204, was supplied from Japan Polypropylene (JPP) Ind., Co., Ltd., Japan, with a melt flow index (MFI) of 1.9 g/10 min.

Preparation of CNT/ZrP nanocomposites

### Synthesis and Exfoliation of ZrP Nanoplatelets

The synthesis and exfoliation of ZrP nanoplatelets in this study are similar to the methods reported previously [Refs.40 and 42]. ZrP nanoplatelets were synthesized through a refluxing method: 20.0 g ZrOCl₂.8H₂O (Fluka) was refluxed in 200.0 mL 3.0 M in a Pyrex round-bottomed flask with stirring at 100° C. for 24 hrs. After the reaction, the products were washed and collected by centrifugation three times. Then, the ZrP was dried at 85° C. in an oven for 24 hrs. The dried ZrP was ground with a set of mortar and pestle into a fine powder.

The ZrP prepared was exfoliated by TBA⁺OH⁻ (Aldrich) in water with a molar ratio of α-ZrP:TBA=1:0.8. TBA is added to a dispersion of ZrP and stirred for at least two hours to achieve TBA intercalation in the nanoplatelets. The dispersion is then sonicated for at least 1 hour (more time may be needed depending on volume of the dispersion) to achieve full exfoliation in solution.

### Acid Treatment of CNT

CNT were treated in acid to introduce carboxylic groups on the surface of the nanotubes. A mixture of sulfuric acid and nitric acid (36 ml/12 ml volume ratio) was prepared. The acid mixture was added to 0.2 g of carbon nanotubes (purity 90%, average diameter <10 nm, length range 0.1-10 μm form Aldrich) and sonicated for 2 hours. The water in the ultrasonicator was circulated to maintain constant water temperature. Then, 152 ml of deionized water was added to the acid/CNT mixture and this solution was sonicated for 1 hour in circulating water. Subsequently, the CNT are filtered off using a polyvinylidene difluoride filter membrane (Millipore, 0.45 μm pore size) and washed thoroughly with deionized water to remove all traces of acid. The washed CNT were redispersed in deionized water and sonicated for three hours. Typically, the final concentration of CNT in water is 0.002 g/ml to 0.005 g/ml.

### Preparation of CNT/ZrP Dispersion

The CNT/ZrP dispersion is prepared in a 1 to 3 weight ratio. As an example, 0.2 g of CNT requires 0.6 g of ZrP to form a stable dispersion. Typically a dispersion of 1 g of ZrP is prepared in 100 ml of water and exfoliated according to the method described before. For a sample of 0.6 g of ZrP, 60 ml of the dispersion will be used to prepare the CNT/ZrP dispersion. The CNT/water dispersion is added to the fully exfoliated ZrP/water dispersion and sonicated for at least an hour to form a stable dispersion. The stable CNT/ZrP dispersion in water was heated to remove most of the water until the CNT/ZrP condensed into a gel. Subsequently, 25 ml of N,N-dimethylformamide (DMF) (Alfa Aesar) was mixed with the gel. The mixture was sonicated for at least one hour to re-disperse the CNT/ZrP in DMF.

For the preparation of CNT/ZrP nanocomposite using a direct blending approach, the CNT/ZrP water dispersion was heated until all the water was completely removed. The dried residue was placed in an oven and dried at 90° C. overnight. The dried CNT/ZrP residue was ground into a fine powder by mortar and pestle.

### Preparation of CNT/ZrP PP Dispersion

0.8 g of PP (Novatec, JPP) was added to 200 ml of decalin (Sigma Aldrich) and heated to 130° C. in an oil bath until all PP pellets were dissolved. 25 ml of isopropanol was added to the solution followed by the CNT/ZrP dispersion in DMF prepared in the previous section was added to the solution while stirring at 122° C. for 10 minutes. The flask containing the solution was transferred to a bath sonicator (Bransonic® 1510) and sonicated for 20 min with the bath temperature at 80° C. The flask was transferred to an oil bath and maintained at 90° C. for 30 minutes under constant stirring. Black precipitates which readily settled to the bottom of the flask appeared and the clear solution was removed and the remaining precipitates were collected by redispersing them in isopropanol (EMD Chem). The precipitates were centrifuged and the supernatant removed. This process of redispersion in isopropanol and removal of supernatant after centrifugation was repeated three times. After which the precipitates were dried at 80° C. under vacuum for 24 hours. The composition of the precipitates is CNT/TBA/ZrP/PP =1/2/3/4 in weight ratio.

### Preparation of CNT/ZrP PP Nanocomposite

The precipitates and powders obtained in the previous sections were used as a masterbatch to be diluted in neat PP (Novatec, JPP) to form nanocomposites with the desired CNT/ZrP loading. The masterbatch were premixed with a certain amount of PP, after which the mixture was loaded into the mixing chamber of a twin screw batch mixer (Haake Rheocord System 40). Table 1 describes the composition used in preparing the nanocomposites. The melt blending was carried out at 180° C. for 10 minutes with mixer screw at 60 rpm. The nanocomposites were then injection molded using a mini-injection molder (CS-183 MMX, CSI) into rectangular bars of 75 mm×12.5 mm×3.15 mm. The melt chamber was kept at 180° C. and the mold was kept at 80° C. To prepare bars of neat PP, the melt chamber was kept at 210° C. and the mold was kept at 80° C.

TABLE 1

| | CNT | ZrP | CNT Masterbatch | Neat PP | Type of |
|---|---|---|---|---|---|
| | wt % | wt % | wt/g | wt/g | Masterbatch |
| JPP-B | 1 | 3 | 1 | 15.60 | Dried CNT/ZrP |
| | | | | | powder |
| JPP-C | 0.2 | 0.6 | 0.32 | 19.94 | Solution processed |
| | | | | | CNT/ZrP/PP |
| | | | | | precipitate |
| JPP-D | 1 | 3 | 1.33 | 15.24 | Solution processed |
| | | | | | CNT/ZrP/PP |
| | | | | | precipitate |

### Preparation of CNT PP Nanocomposite—A Solution Method

The preparation of exfoliated MWCNT in aqueous solution follows the procedure described by Xi et al and will not be described in detail here. 0.002 g of MWCNTs in a 15 g aqueous solution was prepared followed by the addition of 0.02 g of octadecylamine (CH₃(CH₂)₁₇NH₂) powder. The mixture was stirred continuously at 85˜90° C. for 1 hour, allowing octadecylamine to modify the carbon nanotubes. The amine-modified MWCNTs (F-MWCNTs) precipitate out of the aqueous solution once stirring is stopped. This precipitate was collected and dried in an oven at 80° C. for 2 hours. 15 g of xylene was added to the precipitate sonicated for 1 hour to achieve full dispersion. 1 g of PP was dissolved in 15 g of decalin 170° C. The F-MWCNT/xylene solution was added dropwise into the PP/decalin solution under stirring to form a homogeneous mixture. The mixture was stirred for a further 30 min at 170° C. with partial evaporation of the solvent. The final product is a viscous gel of F-MWCNT dispersed in PP. F-MWCNT/PP nanocomposite can be obtained by drying out the gel completely of decalin.

### Preparation of PP/ZrP Nanocomposites—A Solution Method

The preparation of exfoliated ZrP/TBA in aqueous solution has been reported earlier [Ref. 41]. The ZrP can be separated from TBA by adding 0.6 ml of HCl (pH=1) in log of an aqueous solution that contains 0.01 g of ZrP/TBA. The purified ZrP nanoplatelet precipitate was collected by centrifugation and re-dispersed in water with ultrasonication. The purified ZrP of 0.01 g in 10 g of aqueous solution was then modified with an addition of 1 g of 10 wt % octadecylamino salt (CH₃(CH₂)₁₇NH₃⁺) in the solution. The mixture was stirred continuously at room temperature for 1 hour, allowing octadecylamino salt to fully modify the ZrP surface. The amino-modified ZrP (F-ZrP) would precipitate from the aqueous solution once stirring was stopped. Then, 15 g of xylene was added to the precipitate in an aqueous solution and sonicated for 1 hour to achieve full dispersion of F-ZrP in xylene and water decanted. Afterwards, 1 g of PP was dissolved in 15 g of decalin at 170° C. The F-ZrP/xylene solution was added dropwise into the PP/decalin solution under stirring to form a homogeneous mixture. The mixture was stirred for another 30 min at 170° C. with partial evaporation of the solvent. The final product is a viscous gel of F-ZrP dispersed in PP. F-ZrP/PP nanocomposite can be obtained by drying the gel completely.

### Preparation of PP/ZrP/CNT Nanocomposites—A Solution Method

The processes for dispersing F-ZrP/xylene and F-MWCNT/xylene have been described above. About 15 g of xylene was added to the F-ZrP and F-MWCNT (solid content: ZrP 0.01 g and MWCNT 0.0022 g) separately and sonicated for 1 hour to achieve full dispersion. Two dispersions were then mixed with each other with 1 hr of sonication to achieve full dispersion. Then, 1 g of PP was dissolved in 15 g of decalin at 170° C. The F-ZrP/F-MWCNT/xylene solution was added dropwise into the PP/decalin solution under stirring to form a homogeneous mixture. The mixture was stirred for another 30 min at 170° C. with partial evaporation of the solvent. The final product is a viscous gel of F-ZrP/F-MWCNT dispersed in PP. F-ZrP/F-MWCNT/PP nanocomposite can be obtained by drying the gel completely.

### Transmission Electron Microscopy

For the microscopy of CNT/ZrP PP nanocomposite, the masterbatch was redispersed in isopropanol and sonicated for 24 hours to obtain a fine dispersion. A drop of the dispersion was placed on a carbon film coated copper grid for TEM. Thin sections of the nanocomposites were cut out of the injection molded bar using a Reinzcut ultramicrotome and placed on a copper grid.

For the CNT PP nanocomposite, a droplet of MWCNT/PP decalin solution was placed on a copper grid covered by a carbon film. The copper grid was dried by heating on a hotplate until all the solvent was removed.

Transmission electron microscopy (TEM) was performed using a JEOL 1200 EX.

### X-Ray Diffraction

Samples of nanocomposites were analyzed using a Bruker-AXS D8 X-ray powder diffractometer.

### Preparation of ZrP Nanocomposites

### Plasma Treated Polypropylene (PP)

Polypropylene powders comprising micro-particles of 100 microns were treated by plasma under air and nitrogen at atmospheric pressure. During the treatment process, polar groups such as COOH, C═O, C—O, NO₂ and NO were introduced to the surface of the particles. The plasma treated polypropylene (PT-PP) particles were subsequently modified by ZrP nanoplatelets.

### Preparation of ZrP/Plasma Treated PP Dispersion

A stock solution of exfoliated ZrP nanoplatelets in water was prepared as described before with a concentration of 1 g of ZrP in 100 ml of water. For the sample P-PP-1, 0.05 g of ZrP, 5 ml of the stock solution was prepared in a vial. 0.1 g of PT-PP particles was added to the solution of exfoliated a-ZrP nanoplatelets. For the sample P-PP-2, a similar procedure was followed, except that 0.1 millimoles of TBA were also added to the solution. The solutions containing the PT-PP particles were sonicated for 0.5 hours and then stirred continuously for at least 2 hours at ambient temperature. A volume of acetone equivalent to 3 times the volume of water is added to the solution to force the particles to settle to the bottom. Typically, the particles are completely removed from the solution after 1 hour. Then, the supernatant is drained off and the remaining particles are dried by mild heating at 90° C. The dried particles are used for characterization and thermal processing later.

### Preparation of ZrP Nanocomposites

The dried PT-PP particles prepared by the method described in the previous section was sandwiched between two steel plates and pressed using a hot press (Dake) at 170° C. for 5 minutes to form a thin sheet of polymer of 200 to 400 microns thick.

### Preparation of Melt-Blended ZrP PP Nanocomposites

The PT-PP particles modified by ZrP (ZrP-m-PTPP) were blended with PP as follows to further improve the dispersion of ZrP. ZrP-m-PTPP were added to neat PP in a batch mixer and blended at 180° C. to break up the ZrP aggregates, as follows: The PT-PP particles modified by ZrP according to the previous procedure (P-PP-1) were blended with PP using the Haake mixer at 60 rpm for 20 minutes. 0.06 2 of P-PP-1 powder was added to 40 g of PP to obtain 0.015 wt % ZrP PP nanocomposites. This nanocomposite was designated P-PP-8.

### Field Emission Scanning Electron

Particles were placed on the surface of an aluminum stub lined with carbon tape and coated with platinum 4 nm thick under argon using a sputter coater (Cressington). The sample was imaged by a field emission scanning electron microscope (Quanta 600, FEI).

### Transmission Electron Microscopy

PT-PP powder treated with ZrP were placed in a centrifuge tube with 10 ml of 1 vol % solution of 3-glycidoxypropyltrimethoxysilane (Z-6040 Dow Chem.) in methanol for 5 min. Then the solution was siphoned off leaving the powder at the bottom of the centrifuge tube. 5 ml of propylene oxide was added to the powder and shaken, followed by centrifugation and removal of supernatant. Epoxy resin was prepared according to the following formulation, 5.67 g of dodecyl succinic anhydride, 2.48 g of Araldite 502 and 1.85 g of Quetol 651 (all from Electron Microscopy Science EMS). This formulation was stirred thoroughly to ensure homogeneous mixing. Subsequently, 0.2 ml of benzyldimethylamine (EMS) was added to the formulation while stirring. The epoxy resin is poured into the centrifuge tube containing the silane treated powder and cured at 55° C. overnight.

For the hot pressed thin sheets of ZrP nanocomposites, a specimen of an appropriate size was cut and treated with 3-glycidoxypropyltrimethoxysilane, which will be described in the following. A 1 vol % solution of 3-glycidoxypropyltrimethoxysilane (Z-6040 Dow Chem.) in methanol was prepared. About 10 ml of this solution is poured into a petri dish and placed into a glass container. The specimen is placed in the glass container after which the container is sealed and heated to 40° C. for 30 minutes. This allows the silane solution to evaporate and saturate the container. The surface of the specimen will be coated with a thin layer of silane which aids in bonding with the epoxy resin. The silane treated specimen is then placed in a centrifuge tube and the epoxy resin is poured into the tube. The epoxy resin is then cured at 55° C. overnight. Thin sections were prepared from the cure epoxy block and placed on a copper grid.

For P-PP-8, a compression molded block was prepared which was ultramicrotomed to prepare thin sections. The thin sections were placed on carbon film coated copper grids. A 10 nm layer of carbon was coated onto the thin sections using a Cressington Carbon Coater.

Thin sections were cut using a Reichert-Jung Ultracut E ultra-microtome and placed on a copper grid. Transmission electron microscopy (TEM) was performed using a JEOL 1200 EX.

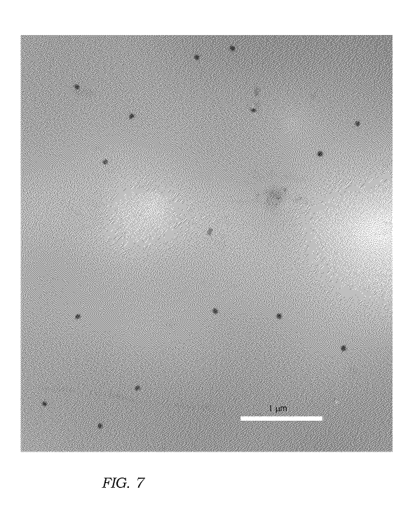

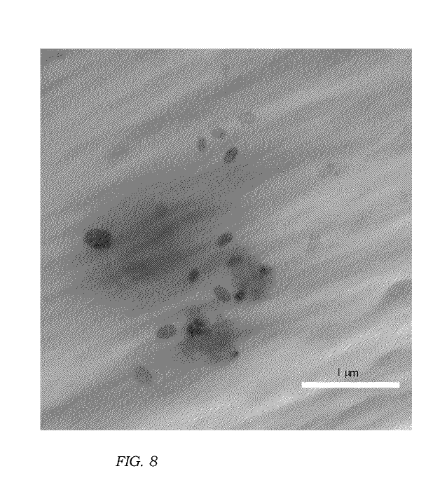

TEM images of P-PP-8 show the homogeneous distribution of ZrP in the matrix (FIG. 7) and evidence of the breaking up of ZrP aggregates (FIG. 8).

### Preparation of CNT Nanocomposites

### Disentanglement of MWCNTs

Pristine-MWCNTs were oxidized according to a procedure described in the present inventors previous work [Refs. 20 and 21]. Fully exfoliated ZrP nanoplatelets were added to slightly oxidized MWCNT in aqueous solution at a weight ratio of CNT:ZrP =1:5 to disentangle and disperse the MWCNTs. The mixture was sonicated (Branson 2510) at room temperature for 30 min. ZrP was subsequently removed from the solution by addition of a acid, and separation of the resulting mixture wherein the MWCNTs remain suspended in the surfactant solution. Concentrations up to 500 parts per million (ppm) were successfully prepared in this manner.

### Preparation of F-MWCNTs

The MWCNTs were functionalized by direct mixing of the well-dispersed aqueous MWCNT solution with octadecylamine powder. The mixture was stirred continuously at 85-90° C. for 1 hour to allow the reaction to complete, after which the octadecylamine-modified MWCNTs (F-MWCNTs) was precipitated out of the aqueous solution. The precipitate was collected and dried in an oven at 80° C. overnight.

### Preparation of Disentangled MWCNT/PP Nanocomposites

Fifteen grams of xylene was added to the precipitated F-MWCNTs and sonicated for 1 hour to achieve individual dispersion of F-MWCNT in xylene. One gram of PP was then added to the F-MWNT/xylene solution with mechanical stirring. The mixture was stirred for one hour at 125° C. to yield a homogenous mixture. The PP/F-MWCNT was forced to precipitate from solution with addition of ethanol. Ethanol was also used to wash the surface several times to remove any residual xylene. The final PP/F-MWNT powder was then dried in a vacuum oven at 80° C. for 12 hours. PP/F-MWNT nanocomposite plaques were prepared for electrical conductivity measurements by hot-pressing the powder at 180° C. for 1 min.

### Morphology Characterization

Transmission electron microscopy (TEM) was performed using a JEOL 2010 high-resolution transmission electron microscope at 200 kV. The solution samples were coated on copper grids containing a thin carbon coating and dried at room temperature. Bulk nanocomposite samples were thin-sectioned to about 80 nm in thickness using a Reichert-Jung Ultracut-E microcome for TEM imaging. SEM images were obtained with a Leo Zeiss 1530 VP Field Emission-SEM (FE-SEM).

### Mechanical Testing

Tensile testing specimens were prepared by mixing PP/F-MWCNT obtained from solution mixing with neat PP pellets to achieve designated amount of MWCNT in PP via a Haake mixer (System 40) at 60 rpm and 180° C. for 2 min. After mixing, the blends were allowed to slowly cool at room temperature. Tensile specimens were molded with a mini-injection molder (CS-183 MMX) at fixed melt and mold temperatures of 195° C. and 90° C., respectively, and an injection rate of 0.25 cm³/s. The injection molded bars were machined and characterized in accordance with ASTM D638-08 for tensile testing. Room temperature tensile tests were carried out on an MTS screw-driven test machine with a crosshead speed of 5 mm/min. True strain was measured using a calibrated MTS extensometer (model 632.12B-50). The average elastic modulus and tensile strength are reported with standard deviation based on a minimum of five specimens per sample.

### Dispersion of MWCNTs

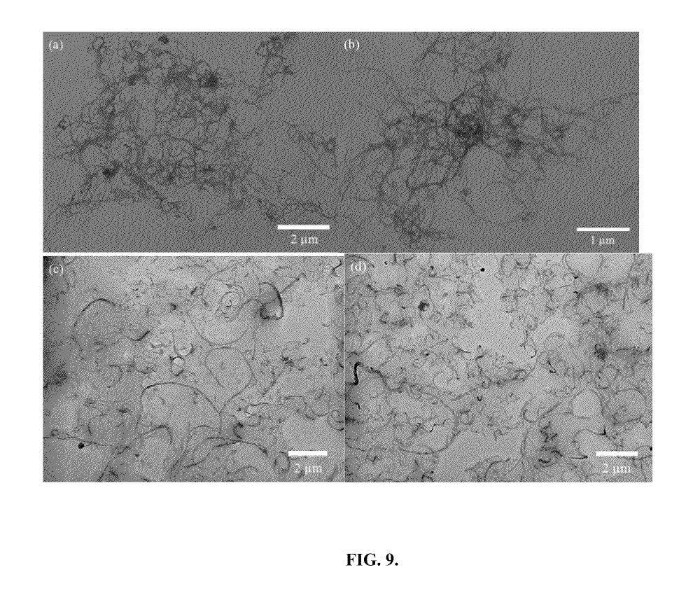

MWCNTs typically form dense entanglements after synthesis because of their tube length and inherent curvature due to tube defects. Fully exfoliated ZrP nanoplatelets have been previously successfully used to disperse and exfoliate CNTs in both solution and polymer matrices [Refs. 20 and 21]. The nanoplatelets can be easily removed from solution by adding an acid to disrupt the electrostatic charge of the nanoplatelets. After washing the tubes with acetone and water, the MWCNT are redispersed in water and remain highly disentangled. FIG. 9 shows the TEM images before and after the present invention MWCNT process. In FIG. 9a-b, slightly oxidized MWCNTs remain entangled. After the disentanglement treatment described here, the MWCNTs show no evidence of aggregation or entanglements by direct observation using TEM. The MWCNTs are well-dispersed and have a curved shape with estimated length between 0.5 and 10 μm (FIG. 9c-d).

### Octadecylamine Functionalization

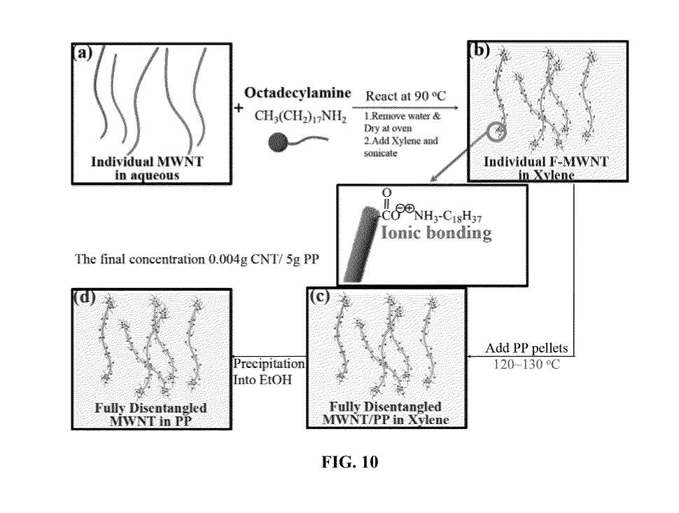

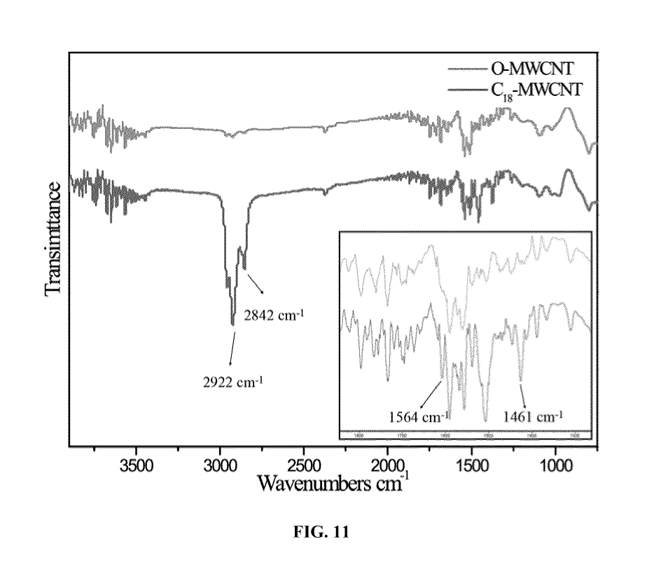

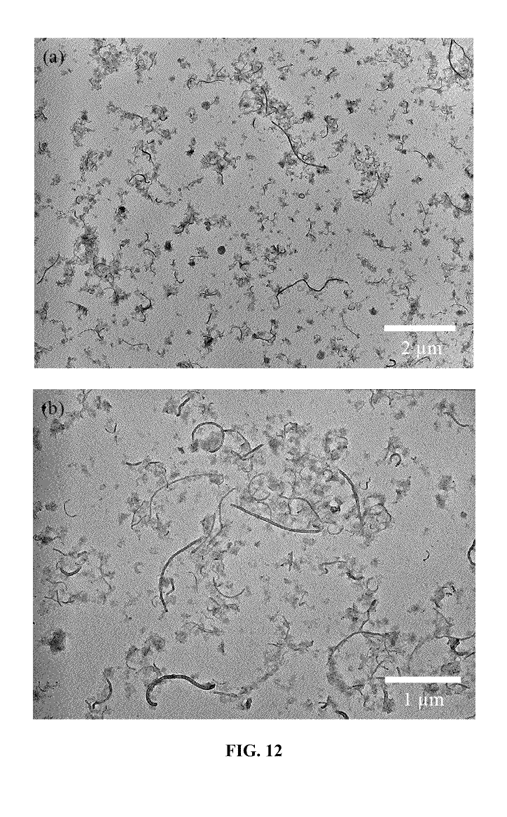

In order to achieve good dispersion and promote wetting of MWNT with the polymer matrix, octadecylamine powder was added to the MWCNT aqueous solution by direct mixing. The addition of octadecylamine powder in well-dispersed MWCNTs aqueous solution leads to ionic attachment of octadecylamine chains with characteristic —COO⁻⁺NH₃— linkages between the MWCNT surface and alkyl group, shown in FIG. 10a-b. The IR spectrum was also acquired to demonstrate the zwitterions formation by comparing F-MWCNT with slightly oxidized MWCNT. As shown in FIG. 11, the peak at 1564 cm⁻¹ indicates the formation of carboxylate anion stretching mode. Also, the peaks shown at 2842 cm⁻¹ and 2922 cm⁻¹ are due to the C—H stretching modes in the octadecylamine alkyl chain. Thus, good dispersion of F-MWCNT in PP can be expected. In contrast to the previous reports [Refs. 17-19], the F-MWCNT can be easily re-dispersed in organic solvent with only minor sonication and shows uniform dispersion prior to mixing with polymer matrix. TEM images of the F-MWNT in xylene show excellent dispersion and full disentanglement at concentration of 100 ppm (FIG. 12). The good dispersion of MWNT is believed to be due to the increase in its organophilicity of the octadecylamine functionalities. The alkyl tails on the MWCNT surface also aid in the dispersion in PP.

### Preparation of PP/F-MWCNT Nanocomposites

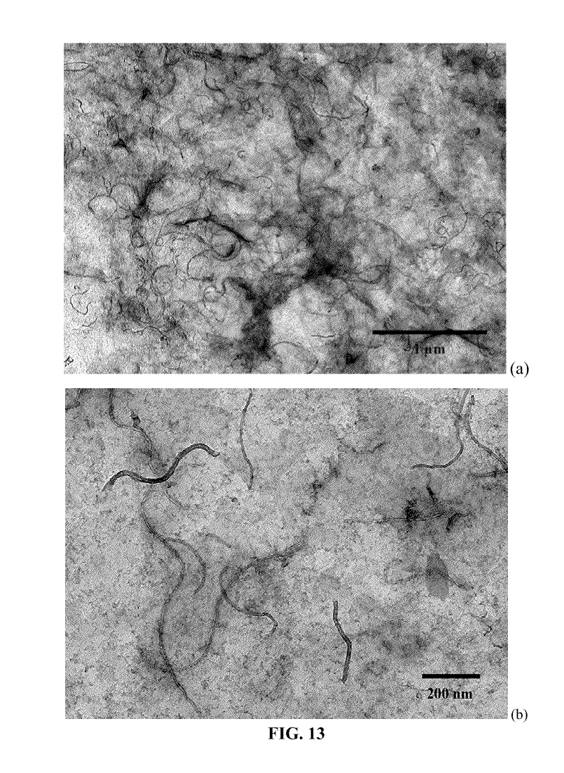

PP/F-MWCNT nanocomposites were prepared by directly adding PP pellets to the F-MWNT/xylene solution at 125° C. (FIG. 10b-c). The concentration of MWCNT was controlled between 0.1 and 2.0% by weight. The PP pellets dissolved with continuous mechanical stirring. TEM images confirm that F-MWCNTs are well dispersed in the PP thin film at 0.5 wt % of MWCNT (FIG. 13). In contrast, even though other works have shown that short alkyl chains can be grafted onto the MWCNT surfaces to improve CNT stability and dispersion in polymers [Refs. 17 and 18], no evidence of good dispersion or disentanglement of MWCNT in polymer matrices has been shown in literature. The PP/F-MWCNT nanocomposites were obtained by removing the xylene solution by evaporation, shown in FIG. 10 c-d. The samples were dried at 80° C. overnight. The nanocomposite thin films for electrical conductivity and TEM microscopy were prepared by hot-pressing samples after drying.

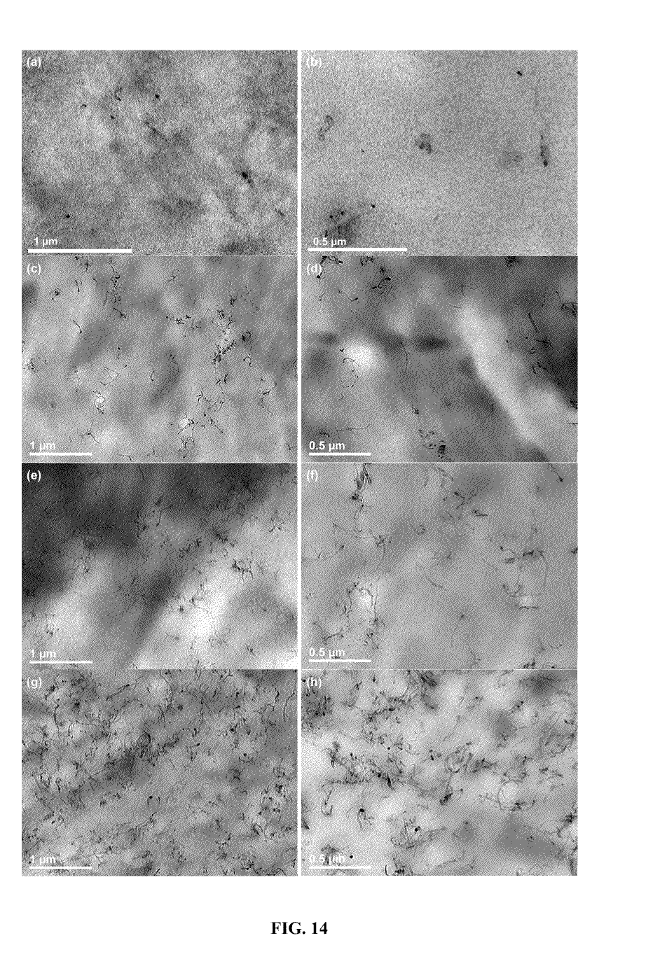

TEM images of thin-sections of PP/F-MWCNT show that the quality of dispersion is maintained even after the removal of solvent. As shown in FIG. 14, PP containing 0.1, 0.6, 1 and 2 wt % of MWCNT in PP exhibit extremely good dispersion, strongly suggesting that the approach presented here is effective at promoting an individual dispersion of MWCNTs at the individual tube level in PP.

### Mechanical Properties of PP/CNTs Nanocomposite

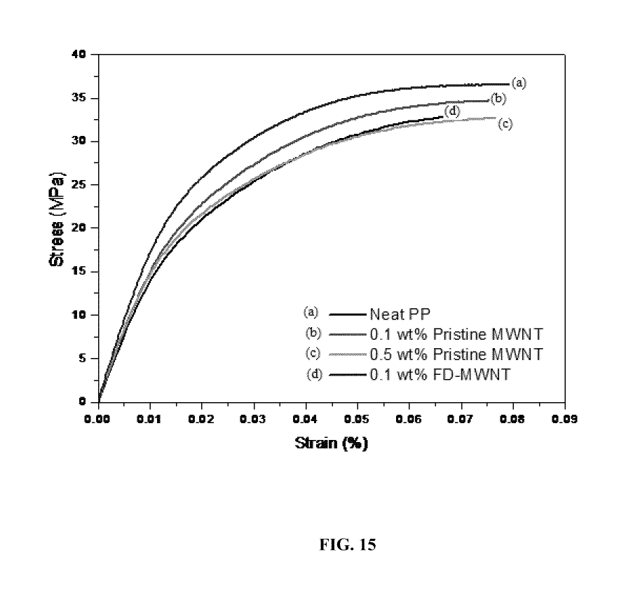

The mechanical properties of the PP/F-MWCNT nanocomposites, as determined under uniaxial tension, are shown in FIG. 15. These results indicate that significant mechanical reinforcement can be realized at MWCNT concentration as low as 0.1 wt %, with ˜50% increase in Young's Modulus and 17% increase in tensile strength observed (Table 2). Control experiments were also performed using pristine MWCNTs dispersion in PP. These systems displayed large agglomerates and showed only margin improvement in Young's modulus and tensile strength (14% and 5% improvement versus neat PP, respectively). The above findings are significant when compared with those reported in the literature [22, 23].

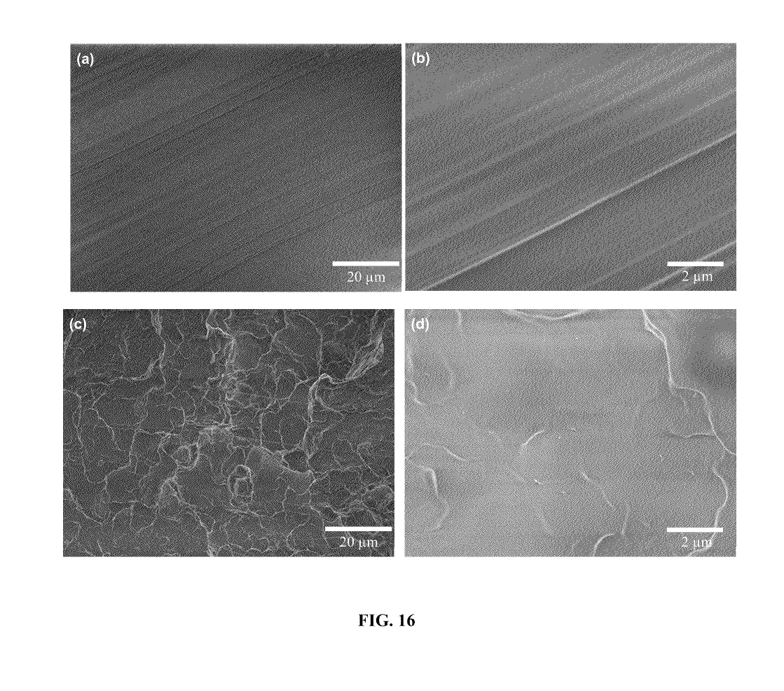

To determine the reinforcement mechanisms that allow the small loading of MWCNTs to contribute to such significant improvements in modulus and strength, SEM images were taken from the tensile fracture surfaces of both neat PP and PP/MWCNT nanocomposites (FIG. 16). The neat PP exhibits high ductility and does not fracture until full necking occurs (FIG. 16a, b). The PP/F-MWCNT shows a significantly different behavior. It fractures during the neck formation and shows widespread micron-size patches on the fracture surface with diameter ˜5 μm at 0.1 wt % F-MWCNT. Careful investigation indicates that MWCNT pull-out is absent, which suggests strong interfacial bonding between the MWCNT and PP matrix (FIG. 16c, d). There may also be reinforcement due to alignment achieved during the injection molding process, or induced nucleation during crystallization.

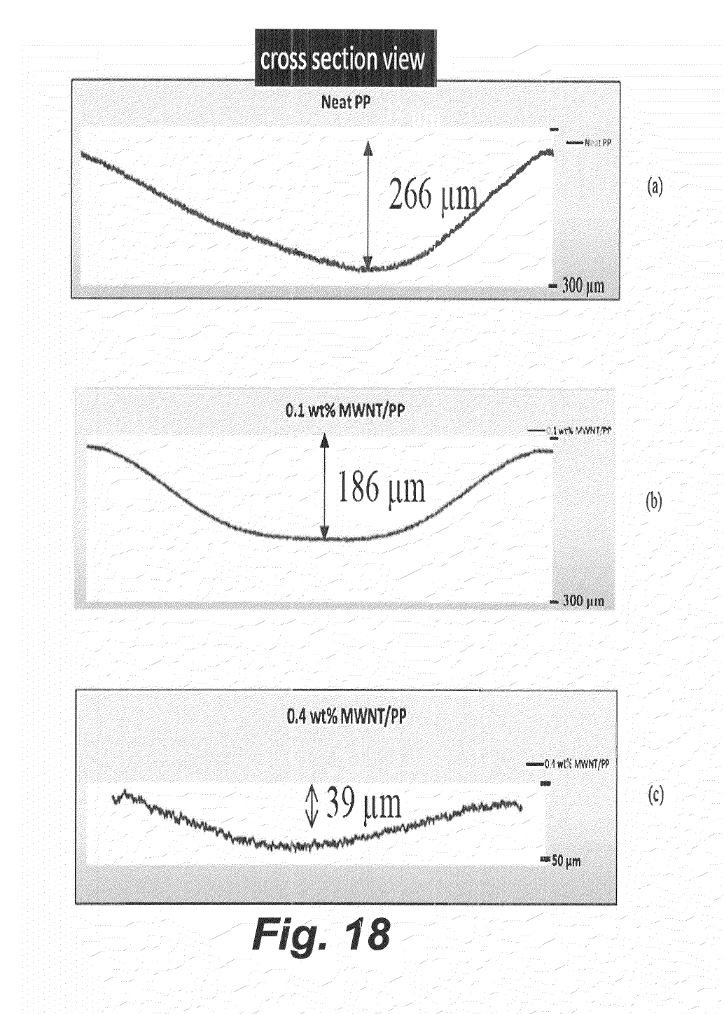

Furthermore, the present invention nanocomposites exhibit high modulus improvements in low loading of CNT (Table 2 below). The present composites also exhibit great dimensional stability after injection molding to retain its shape. The CNT containing PP exhibits an almost rectangular shape from the mold, while neat PP has a significant shrinkage at mid-section. Measurement of mold shrinkage of a bar-shaped blank having dimensions 74 mm long×13 mm wide×3 mm thick of (a) neat PP, (b) 0.1 wt % MWCNTs in PP, and (c) 0.4 wt % MWCNTs in PP was performed by laser confocal microscopy using a Keyence VK-9700 laser confocal microscope and gave shrinkage in the thickness direction (measured as the percentage difference between the thickness of a middle portion of the bar-shaped blank compared to the ends of the bar shaped blank; the bar-shaped blank was prepared in the same manner as that for mechanical testing noted above) in the amounts shown in the following table, and depicted in FIGS. 18(a)-(c), respectively:

Topographical Information

| | 0.1 wt % | 0.4 wt % |
|---|---|---|
| Neat PP | e-MWNT in PP | e-MWNT in PP |
| 266 μm | 186 μm | 39 μm |

Thus, preferred embodiments of nanocomposites of the present invention comprise 95 to 99.7 wt % of polyolefin (most preferably polypropylene), and 0.3 to 5 wt % by weight of nanotubes, have a Young's modulus of more than 2.0 GPa, and a mold shrinkage in thickness direction of less than one fourth of a mold shrinkage of the neat polyolefin.

### Electrical Conductivities of PP/CNTs Nanocomposite

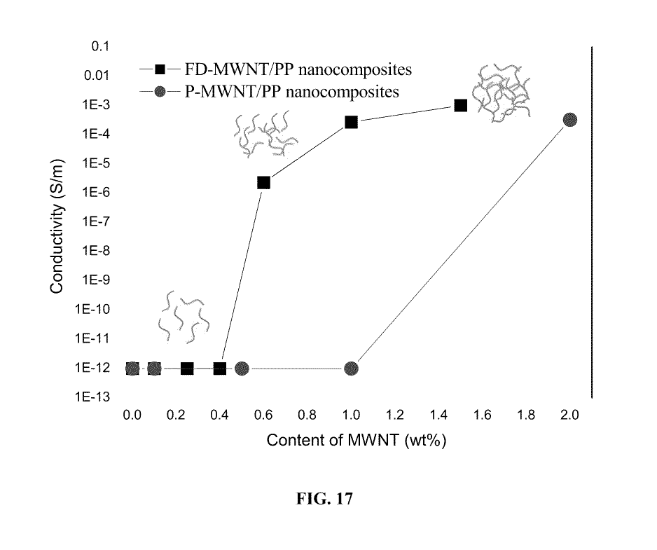

The variation in electrical conductivity as a function of concentration due to the presence of pristine-MWCNT and F-MWCNT was measured based on the surface conductivity taken at 1V (FIG. 17). PP/MWCNT nanocomposites were prepared between 0.1 and 2 wt % by directly hot-pressing the samples after solution evaporation. The PP/P-MWCNT composite undergoes electrical percolation near 2 wt % due to the agglomeration of MWCNTs and the breakdown of the weak network during crystallization. On the other hand, the PP/F-MWCNT nanocomposites show an insulator-conductor percolation transition at 0.6 wt % with conductivity of 2.3*10⁻⁶ S/m. The inset in FIG. 17 provides a conceptual interpretation of the MWCNT dispersion.

At low concentration, there is not sufficient MWCNTs to form conductive paths through the PP matrix. At the percolation threshold, a single electrical pathway is formed to allow electrons to hop along a connected network of tubes throughout the PP matrix. As concentration increases further, more conductive pathways are formed and begin to connect to other paths throughout the system, demonstrating power law behavior as the system becomes coupled. The loading at electrical percolation is the lowest reported value for a non-melt state PP/CNT composite according to [24], which is in contrast to the observation in amorphous systems which typically rely on agglomerated networks for electrical transition [25, 26]. This suggests the F-MWCNT are incorporated into the lamellar structure of the PP during crystallization and act as a nucleation agent, supported by measurements on degree of crystallinity given in Table 2. This behavior may also partially account for the large increase in the elastic modulus and tensile strength observed.

TABLE 2
Mechanical properties of the neat PP and PP nanocomposites
containing well-dispersed MWCNTs.

| | Young's Modulus | Tensile Strength | Crystallinity^{a} |
|---|---|---|---|
| | (GPa) | (MPa) | (%) |
| Neat PP | 1.37 ± 0.07 | 32.53 ± 0.86 | 44 |
| PP/P-MWNTs | 1.57 ± 0.06 | 34.29 ± 0.61 | 49 |
| (0.1 wt %) | | | |
| PP/P-MWNTs | 1.61 ± 0.09 | 33.21 ± 0.63 | 48 |
| (0.5 wt %) | | | |
| PP/FD-MWNTs | 2.08 ± 0.10 | 37.94 ± 1.21 | 48 |
| (0.1 wt %) | | | |

^{a}ΔH = 209 J/g is the theoretical enthalpy value for a 100% crystalline of PP

### REFERENCES

Each of the following references is hereby incorporated by reference in its entirety:
[1] R. Saito, G. Dresselhaus, M. Dresselhaus, Physical properties of carbon nanotubes, Imperial College Pr, 1998.
[2] M. Dresselhaus, G. Dresselhaus, P. Avouris, Carbon nanotubes: synthesis, structure, properties, and applications, Springer Verlag, 2001.
[3] X. Xie, Y. Mai, X. Zhou, Materials Science and Engineering: R: Reports, 49 (2005) 89-112.
[4] X. Gong, J. Liu, S. Baskaran, R. Voise, J. Young, Chem. Mater, 12 (2000) 1049-1052.
[5] M. O'Connell, P. Boul, L. Ericson, C. Huffman, Y. Wang, E. Haroz, C. Kuper, J. Tour, K. Ausman, R. Smalley, Chemical Physics Letters, 342 (2001) 265-271.
[6] V. Georgakilas, K. Kordatos, M. Prato, D. Guldi, M. Holzinger, A. Hirsch, J. Am. Chem. Soc, 124 (2002) 760-761.
[7] C. Dyke, J. Tour, J. Phys. Chem. A, 108 (2004) 11151-11159.
[8] R. Blake, Y. Gun'ko, J. Coleman, M. Cadek, A. Fonseca, J. Nagy, W. Blau, J. Am. Chem. Soc, 126 (2004) 10226-10227.
[9] D. Tasis, N. Tagmatarchis, A. Bianco, M. Prato, Chem. Rev, 106 (2006) 1105-1136.
[10] R. Chen, Y. Zhang, D. Wang, H. Dai, J. Am. Chem. Soc, 123 (2001) 3838-3839.
[11] J. Chen, H. Liu, W. Weimer, M. Halls, D. Waldeck, G. Walker, J. Am. Chem. Soc, 124 (2002) 9034-9035.
[12] J. Chen, M. A. Hamon, H. Hu, Y. Chen, A. M. Rao, P. C. Eklund, R. C. Haddon, Science, 282 (1998) 95-98.
[13] M. A. Hamon, J. Chen, H. Hu, Y. Chen, M. E. Itkis, A. M. Rao, P. C. Eklund, R. C. Haddon, Adv. Mater. 11 (1999) 834-840.
[14] D. Chattopadhyay, S. Lastella, S. Kim, F. Papadimitrakopoulos, 124 (2002) 728-829.
[15] D. Chattopadhyay, I. Galeska, F. Papadimitrakopoulos, J. Am. Chem. Soc. 125 (2003) 3370-3375.
[16] J. Chen, A. M. Rao, S. Lyuksyutov, M. E. Itkis, M. A. Hamon, H. Hu, R. W. Cohn, P. C. Eklund, D. T. Colbert, R. E. Smalley, R. C. Haddon, J. Phys. Chem. B 105 (2001) 2525-2528.
[17] A. Koval'chuk, V. Shevchenko, A. Shchegolikhin, P. Nedorezova, A. Klyamkina, A. Aladyshev, Macromolecules, 41 (2008) 7536-7542.
[18] A. Koval'chuk, A. Shchegolikhin, V. Shevchenko, P. Nedorezova, A. Klyamkina, A. Aladyshev, Macromolecules, 41 (2008) 3149-3156.
[19] J. Lee, S. Yang, H. Jung, Macromolecules, 42 (2009) 8328-8334.
[20] D. Sun, W. Everett, C. Chu, H.-J. Sue, Small, 5 (2009) 2692-2697.
[21] D. Sun, C. Chu, and H.-J. Sue, Chem. Mater., 22 (2010) 3773-3778.
[22] G. Lee, S. Jagannathan, H. Chae, M. Minus, S. Kumar, Polymer, 49 (2008) 1831-1840.
[23] B. Yang, J. Shi, K. Pramoda, S. Goh, Composites Science and Technology, 68 (2008) 2490-2497.
[24] W. Bauhofer, J. Z. Kovacs, Composites Science and Technology, 69 (2009) 1486-1498.
[25] J. Sandler, J. Kirk, I. Kinloch, M. Shaffer, A. Windle, Polymer, 44 (2003) 5893-5899.
[26] C. Martin, J. Sandler, M. Shaffer, M. Schwarz, W. Bauhofer, K. Schulte, A. Windle, Composites Science and Technology, 64 (2004) 2309-2316.
[27] A. Usuki et al., J Mater Res 8, 1 179 (1993).
[28] Y. Kojima et al., J Mater Res 8, 1 185 (1993).
[29] A. Usuki et al., Journal of Applied Polymer Science 63, 137 (1997).
[30] M. Kawasumi et al., Macromolecules 30, 6333 (1997).
[31] N. Hasegawa et al., Journal of Applied Polymer Science 67, 87 (1998).
[32] M. Kato, A. Usuki, and A. Okada, Journal of Applied Polymer Science 66, 1781 (1997).
[33] T. Kashiwagi et al., Macromolecular Rapid Communications 23, 761 (2002).
[34] S. P. Bao, and S.C. Tjong, Mat Sci Eng a-Struct 485, 508 (2008).
[35] R. Blake et al., Journal of the American Chemical Society 126, 10226 (2004).
[36] S. H. Lee et al., Carbon 45, 281 0 (2007).
[37] S. C. Tjong, G. D. Liang, and S. P. Bao, Scripta Materialia 57, 461 (2007).
[38] S. B. Kharchenko et al., Nature Materials 3, 564 (2004).
[39] T. McNally et al., Polymer 46,8222 (2005).
[40] L. Y. Sun et al., New Journal of Chemistry 31, 39 (2007).
[41] D. M. Kaschak et al., Journal of the American Chemical Society 120, 10887 (1998).
[42] L. Y. Sun et al., Chemistry of Materials 19, 1749 (2007).
[43] H.-J. Sue et al., US Published Patent Application 2009/0035469, filed Apr. 30, 2008.

Obviously, additional modifications and variations of the present invention are possible in light of the above teachings. It is therefore to be understood that within the scope of the appended claims, the invention may be practiced otherwise than as specifically described herein.

1. A method of dispersing nanotubes and/or nanoplatelets in a polyolefin, comprising:
A) preparing a solution comprising nanotubes or nanoplatelets or both;
B) stirring the resulting solution from step (A);
C) dissolving at least one polymeric material in the stirred solution from step (B) and isolating precipitates from the solution; and
D) melt-blending the precipitates with at least one polyolefin.

2. The method according to claim 1, wherein the solution of step (A) further comprises at least one dispersant selected from the group consisting of long chain aliphatic amines and maleic anhydride modified polypropylene oligomers.

3. The method according to claim 2, wherein the dispersant is at least one long chain aliphatic amine.

4. The method according to claim 1, wherein the solution of step (A) comprises nanotubes.

5. The method according to claim 1, wherein the solution of step (A) comprises nanoplatelets.

6. The method according to claim 1, wherein the solution of step (A) comprises both nanotubes and nanoplatelets.

7. The method according to claim 4, wherein the nanotubes are at least one member selected from the group consisting of carbon nanotubes, tungsten dioxide nanotubes, silicon nanotubes, inorganic nanotubes, and combinations thereof.

8. The method according to claim 6, wherein the nanotubes are at least one member selected from the group consisting of carbon nanotubes, tungsten dioxide nanotubes, silicon nanotubes, inorganic nanotubes, and combinations thereof.

9. The method according to claim 4, wherein the nanotubes are oxidized by a method selected from the group consisting of dry oxidation, radiation oxidation, plasma oxidation, thermal oxidation, diffusion oxidation and combinations thereof.

10. The method according to claim 7, wherein the nanotubes are carbon nanotubes.

11. The method according to claim 10, wherein the carbon nanotubes are at least one member selected from the group consisting of multi-walled carbon nanotubes, single walled carbon nanotubes, and combinations thereof.

12. The method according to claim 5, wherein at the nanoplatelets are at least one member selected from the group consisting of clay, nanoclay, graphene, inorganic crystal, organic crystal, and combinations thereof.

13. The method according to claim 6, wherein at the nanoplatelets are at least one member selected from the group consisting of clay, nanoclay, graphene, inorganic crystal, organic crystal, and combinations thereof.

14. The method according to claim 6, comprising removing the nanoplatelets from the stirred solution from step (B), prior to the dissolving of step (C).

15. The method according to claim 1, wherein the at least one polymeric material is a member selected from the group consisting of polyethylene terephthalate, polybutylene terephthalate, polyestercarbonate copolymers, poly(ester-carbonate) resins, polyamides, high temperature polyamides, polyethylene, polypropylene, copolymers of olefins, functionalized polyolefin, halogenated vinyl polymers, vinylidene polymers, polyvinylidene chloride, polyvinyl fluoride, polyvinylidene fluoride, polyamide copolymers, polyacrylonitrile, polyethers, polyketones, thermoplastic polyimides, modified celluloses, and mixtures including at least one of the foregoing polymeric materials.

16. The method according to claim 1, wherein the melt-blending of step (D) is a melt-blending of the precipitates with at least one polyolefin and one or more additives selected from the group consisting of fillers, reinforcing agents, plasticizers, antioxidants, heat stabilizers, ultraviolet stabilizers, tougheners, antistatic agents, flame retardant, colorants, and a combination containing at least one of the foregoing additives.

17. The method according to claim 1, wherein the at least one polyolefin is at least one member selected from the group consisting of polyethylene, polypropylene, and blends and copolymers thereof.

18. The method according to claim 1, wherein the dissolving of step (C) further comprises sonicating the solution, followed by cooling to form the precipitates.

19. The method according to claim 18, further comprising drying the precipitates prior to melt blending.

20. The method according to claim 1, wherein the at least one polymeric material is polypropylene.

21. The method according to claim 1, wherein the solution prepared in step (A) further comprises surface-modified polypropylene.

22. The method according to claim 21, wherein the surface-modified polypropylene is a plasma-treated polypropylene.

23. The method according to claim 17, wherein the at least one polyolefin is polypropylene.

24. The method according to claim 1, wherein the at least one polyolefin is in a form of particles, fibers, or tubes.

25. The method according to claim 1, wherein the dissolving of step (C) further comprises addition of a non-polar solvent prior to dissolving the at least one polymeric material.

26. The method according to claim 6, wherein the nanotubes and nanoplatelets are each surface modified by reaction with at least one dispersant selected from the group consisting of long chain aliphatic amines and maleic anhydride modified polypropylene oligomers.

27. The method according to claim 1, wherein the solution of step (A) comprises organic solvent such as xylene, decalin, butanol, di-chlorobenzene, tri-chlorobenzene, N,N-dimethylformamide and isopropanol.

28. A nanocomposite prepared according to claim 1.

29. A method of forming an article, comprising injection molding, extrusion molding, stretch blow molding or thermoforming the nanocomposite according to claim 27.

30. A nanocomposite comprising 95 to 99.7% by weight of polyolefin, and 0.3 to 5% by weight of nanotubes and/or nanoplatelets and having a surface electrical conductivity of more than 10⁻⁶ S/m.

31. A nanocomposite comprising 95 to 99.7% by weight of polyolefin, and 0.3 to 5% by weight of nanotubes and/or nanoplatelets, wherein the nanocomposite has a Young's modulus of more than 2.0 GPa.

32. The nanocomposite of claim 31, wherein the nanocomposite further has a mold shrinkage in a thickness direction that is less than one fourth a mold shrinkage of the polyolefin alone.

33. A method of dispersing carbon nanotubes in a polyolefin, comprising:
providing an aqueous dispersion comprising carbon nanotubes;
functionalizing the carbon nanotubes by combining the aqueous dispersion comprising carbon nanotubes with at least one long chain aliphatic amine, to provide an aqueous dispersion of functionalized carbon nanotubes;
removing water from the aqueous dispersion to isolate the functionalized carbon nanotubes;
combining the isolated functionalized carbon nanotubes with a non-polar organic solvent to provide an organic solution of functionalized carbon nanotubes;
combining the organic solution of functionalized carbon nanotubes with at least one polymeric material and removing the organic solvent to isolate precipitates of functionalized carbon nanotubes in the at least one polymeric material; and
melt-blending the precipitates with at least one polyolefin.

34. A method of dispersing nanoplatelets in a polyolefin, comprising:
providing an aqueous dispersion comprising nanoplatelets;
functionalizing the nanoplatelets by combining the aqueous dispersion comprising nanoplatelets with at least one long chain aliphatic amine, to provide an aqueous dispersion of functionalized nanoplatelets;
removing water from the aqueous dispersion to isolate the functionalized nanoplatelets;
combining the isolated functionalized nanoplatelets with a non-polar organic solvent to provide an organic solution of functionalized nanoplatelets;
combining the organic solution of functionalized nanoplatelets with at least one polymeric material and removing the organic solvent to isolate precipitates of functionalized nanoplatelets in the at least one polymeric material; and
melt-blending the precipitates with at least one polyolefin.
